(19) United States
(12) Patent Application Publication
(10) Pub. No.: US 2007/0276070 A1
(43) Pub. Date: Nov. 29, 2007

(54) Poloyoxymethylene Composition Having High Fuel Resistance And Shaped Article Produced Therefrom

(76) Inventors: Tak-Kyu Kim, Kyungki-do (KR); Chung-Ryol Jeong, Kyungki-do (KR); Ki-Chul Shin, Kyungki-do (KR)

Correspondence Address: MCDERMOTT WILL & EMERY LLP, 600 13TH STREET, N.W., WASHINGTON, DC, 20005-3096, US

(21) Appl. No.: 10/584,050

(22) PCT Filed: Dec. 17, 2004
(86) PCT No.: PCT/KR04/03333

§ 371 Date: Jun. 8, 2007

(30) Foreign Application Priority Data
Dec. 22, 2003 (KR) 10-2003-0094542

(51) Int. Cl. C08L 59/00; C08J 5/00; C08K 3/24; C08K 5/13

(52) U.S. Cl. 524/400

(57) ABSTRACT

Disclosed is a polyoxymethylene composition having high fuel resistance, which includes a polyoxymethylene polymer, magnesium stearate, and an antioxidant. Also, a shaped article produced from the polyoxymethylene composition is provided, which is suitable for use in fuel feeding and circulation systems of automobiles.

### TECHNICAL FIELD

The present invention relates, generally, to a polyoxymethylene composition having high fuel resistance, and a shaped article produced therefrom, which is suitable for use in fuel feeding and circulation systems of automobiles. More specifically, the present invention relates to a polyoxymethylene composition having high fuel resistance, which includes magnesium stearate.

### BACKGROUND ART

As global automotive markets have continuously pursued lightweight and monolithic structures, metal materials used for fuel-related components of automobiles have been replaced by plastics. Further, properties required for such plastics gradually become stringent.

The fuel-related components of automobiles are composed of polyoxymethylene (hereinafter, abbreviated as ‘POM’), polyamide 6, polyamide 12, polybutylene terephthalate, polyphenylene sulfide, high density polyethylene, etc., depending on operation conditions thereof.

POM, which is a crystalline resin, has high mechanical properties, creep resistance, fatigue resistance, wear resistance and chemical resistance, and thus, is widely applied to components requiring complex properties, such as various electric and electronic products, automotive components and other mechanical mechanisms.

In particular, the amount of POM used in automobiles increases in accordance with the development of automotive industries, in which the POM is increasingly used in fuel systems.

Typically, the fuel system of a gasoline-powered automobile which includes POM is operated at a maximum of 65° C., which is an operation temperature suitable for the POM.

However, in the case of an automobile with a diesel engine developed recently, a fuel-related component is operated at a maximum of 100-120° C., which is drastically increased in comparison with conventional temperatures. Thus, the automotive components made of POM should be able to meet the above requirements. Further, diesel fuel is known to age at a high temperature, which causes decomposition of POM.

In addition, a sulfur compound present in the diesel fuel is oxidized when being exposed to air, to produce an acidic sulfur compound, which acts to cause the decomposition of POM.

Also, oxides, acting to cause the decomposition of POM, are formed even in aggressive gasoline fuel, thus remarkably decreasing the durability of the fuel system.

Therefore, a material used for an automotive component in direct contact with fuel should have high mechanical properties and fuel resistance.

In this regard, U.S. Pat. No. 6,489,388 discloses a thermoplastic molding composition including zinc oxide and polyethylene glycol as a fuel resistant composition comprising POM. However, since the fuel resistant (diesel resistant) composition including zinc oxide and polyethylene glycol retains only about 40-50% of tensile elongation, an improvement of the above composition to fuel resistance is not large.

To fulfill more stringent requirements of automotive manufacturers, a POM composition having further improved fuel resistance is needed.

### DISCLOSURE OF THE INVENTION

Accordingly, the present invention has been made keeping in mind the above problems occurring in the related art, and an object of the present invention is to provide a POM composition having high resistance to aggressive gasoline fuel and diesel fuel having a large content of sulfur compounds.

It is another object of the present invention to provide a shaped article produced from the POM composition, which is suitable for use in fuel feeding and circulation systems of automobiles requiring high fuel resistance.

The above objects are accomplished by a provision of a POM composition having high fuel resistance, which comprises 100 parts by weight of polyoxymethylene polymer (A); 0.1-2.0 parts by weight of magnesium stearate (B); and 0.01-1.0 parts by weight of an antioxidant (C).

In addition, the POM composition further comprises 0.01-2.0 parts by weight of a thermal stabilizer (D). As well, the POM composition, which comprises the components (A), (B) and (C), or the components (A), (B), (C) and (D), further comprises 50 parts by weight or less of a reinforcing agent (E).

Further, the present invention provides a shaped article produced from the above POM composition, which is suitable for use in fuel feeding and circulation systems of automobiles requiring high fuel resistance.

### BEST MODE FOR CARRYING OUT THE INVENTION

Hereinafter, a detailed description will be given of the present invention.

According to the present invention, a POM resin composition (hereinafter, referred to as ‘POM composition’), obtained by adding magnesium stearate as an inorganic antacid to a POM resin, has high fuel resistance.

That is, the POM composition of the present invention manifests fuel resistance of high tensile strength and tensile elongation without causing the decomposition of POM even in the presence of aggressive gasoline and hot diesel having a larger content of sulfur compounds. Aggressive gasoline fuel means gasoline including various compounds able to cause the decomposition of POM.

Used as a main ingredient in the POM composition having fuel resistance of the present invention, a POM polymer (A) may be any of a homopolymer of an oxymethylene group represented by Formula 1, below, or a copolymer resulting from a random copolymerization of a monomeric group of Formula 1 and a monomeric group represented by Formula 2, below. The POM polymer (A) preferably has a molecular weight in a range from 10,000 to 200,000 g/mol:
—(—CH₂O—)— Formula 1
—[—(CX₁X₂)ₓO—]— Formula 2

Wherein X₁ and X₂, which are the same or different, are each hydrogen, an alkyl group or an aryl group, and x is an integer of 2 to 6.

The oxymethylene homopolymer is produced by polymerization of formaldehyde or a cyclic oligomer thereof, that is, trioxane. Also, the oxymethylene copolymer, which results from the random copolymerization of the monomeric group of Formula 1 and the monomeric group of Formula 2, is obtained by randomly copolymerizing formaldehyde or the cyclic oligomer thereof and cyclic ether represented by Formula 3 or cyclic formal represented by Formula 4:

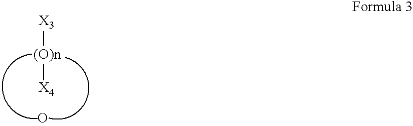

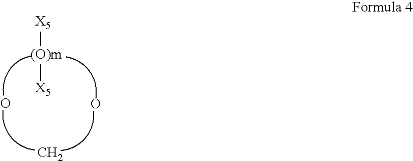

Wherein X₃, X₄, X₅ and X₆, which are the same or different, are each hydrogen or an alkyl group and may be linked to the same carbon atom or different carbon atoms, and n and m are each an integer from 2 to 6.

As the comonomer used for the random copolymerization, cyclic ether includes, for example, ethyleneoxide, propyleneoxide, butyleneoxide, phenyleneoxide, etc., and cyclic formal includes, for example, 1,3-dioxolane, diethyleneglycolformal, 1,3-propanediolformal, 1,4-butanediolformal, 1,3-dioxepanformal, 1,3,6-trioxocane, etc.

Preferably, the comonomer selected from among ethyleneoxide, 1,3-dioxolane, 1,4-butanediolformal, and combinations thereof is used. The above comonomer is added to trioxane or formaldehyde as a main comonomer, and then randomly co polymerized in the presence of a Lewis acid catalyst, thereby producing an oxymethylene copolymer having a melting point of 150° C. or higher with at least two adjacent carbon atoms in the main chain.

In the oxymethylene copolymer, a molar ratio of oxymethylene molecular structure to oxymethylene repeat unit is in the range of 0.05 to 50, and preferably, 0.1 to 20.

The catalyst used in polymerization to obtain the oxymethylene polymer includes an anionic catalyst or a cationic catalyst, which are known in the art. The catalyst for polymerization of trioxane is exemplified by halogens, such as chlorine, bromine, and iodine; organic and inorganic acids, such as alkyl- or allyl-sulfonic acid, HClO₄, HIO₄, HClO₄ derivatives, CPh₃C(IO₄), and R₃SiHSO₄; metal halogen compounds, such as BF₃, SbF₃, SnCl₄, TiCl₄, FeCl₃, ZrCl₄, MoCl₅, and SiF₄; complexes of metal halogen compounds, such as BF₃.OH₂, BF₃.Et₂, BF₃.OBu₂, BF₃.CH₃COOH, BF₃.PF₅.HF, BF₃-10-hydroxyacetophenol, Ph₃CSnCl₅, Ph₃CBF₄, and Ph₃CSbCl₆; metal ester, such as carboxylate compounds of copper, zinc, cadmium, iron, cobalt, and nickel; metal oxides, such as P₂O₅+SO₂, and P₂O₅+phosphate ester; and combinations of organic metal and metal halogen compounds. Of the above catalysts, it is preferable that a coordinated compound of boron trifluoride be used. More preferably, BF₃.OEt₂ and BF₃.OBu₂ are used. The catalyst used for polymerization is used in the mol range from 2×10⁻⁶ to 2×10⁻² based on 1 mol of trioxane.

The polymerization may be carried out in a manner of bulk polymerization, suspension polymerization or solution polymerization, at 0-100° C., and preferably, 20-80° C.

On the other hand, an inactivator for inactivating unused catalyst remaining after the polymerization reaction includes, for example, tertiary amines, such as triethylamine, cyclic sulfur compounds, such as thiophene, and phosphorus compounds, such as triphenylphosphine, all of which are Lewis bases having unshared electron pairs and form a complex salt together with the catalyst.

Further, upon production of polyoxymethylene, a chain transferring agent, which is exemplified by alkyl-substituted phenols or ethers, may be used. In particular, alkylether, such as dimethoxymethane, is preferable.

To increase fuel resistance, magnesium stearate (B) as an inorganic antacid is used in an amount of 0.1-2.0 parts by weight, and preferably, 0.5-2.0 parts by weight, based on 100 parts by weight of the POM polymer. If magnesium stearate is added in an amount less than 0.1 parts by weight, there is no improvement to fuel resistance. Meanwhile, if magnesium stearate is added in an amount exceeding 2.0 parts by weight, the properties and thermal stability of the POM composition decrease undesirably.

An antioxidant (C) used in the present invention includes hindered phenols, for example, 2,2′-methylenebis(4-methyl-6-t-butylphenol), hexamethyleneglycol-bis-(3,5-di-t-butyl-4-hydroxyhydrocinnamate), tetrakis [methylene(3,5-di-t-butyl-4-hydroxyhydrocinnamate)]methane, triethyleneglycol-bis-3-(3-t-butyl-4-hydroxy-5-methylphenyl)propionate, 1,3,5-trimethyl-2,4,6-tris(3,5-di-t-butyl-4-hydroxybenzyl)benzene, n-octadecyl-3-(4′-hydroxy-3′,5′-di-t-butylphenol)propionate, 1,6-hexane-diol-bis-3(3,5-di-t-butyl-4-hydroxy-phenyl)propionate, 4,4′-methylenebis(2,6-di-t-butylphenol), 4,4′-butylidene-bis-(6-t-butyl-3-methyl-phenol), di-stearyl 3,5-di-t-butyl-4-hydroxybenzylphosphate, 2-t-butyl-6-(3-t-butyl-5-methyl-2-hydroxybenzyl)-4-methylphenylacrylate, 3,9-bis2-[3-(3-t-butyl-4-hydroxy-5-methylphenyl)propionyloxy]-1,1-dimethylethyl-2,4,8,10-tetraoxaspiro[5,5]undecane, etc.; or hindered amines, for example, 4-acetoxy-2,2,6,6-tetramethylpiperidine, 4-stearoyloxy-2,2, 6,6-tetramethylpiperidine, 4-acryloyloxy-2,2,6,6-tetramethylpiperidine, 4-methoxy-2,2,6,6-tetramethylpiperidine, 4-benzoyloxy-2,2,6,6-tetramethylpiperidine, 4-cyclohexyloxy-2,2, 6,6-tetramethylpiperidine, 4-phenoxy-2,2,6,6-tetramethylpiperidine, 4-benzyloxy-2,2,6,6-tetramethylpiperidine, 4-(phenylcarbamoyloxy)-2,2,6,6-tetramethylpiperidine, bis(2,2,6,6-tetramethyl-4-piperidyl)oxalate, bis(2,2,6,6-tetramethyl-4-piperidyl)alonate, bis(2,2,6,6-tetramethyl-4-piperidyl)adipate, bis(2,2,6,6-tetramethyl-4-piperidyl)sepacate, bis(1,2,2,6,6-pentamethyl-piperidyl)sepacate, bis(2,2,6,6-tetramethyl-4-piperidyl)terephthalate, 1,2-bis(2,2,6,6-tetramethyl-4-piperidyloxy)ethane, bis(2,2,6,6-tetramethyl-4-piperidyl)hexamethylene-1,6-dicarbamate, bis(1-methyl-2,2,6,6-tetramethyl-4-piperidyl)adipate, tris(2,2,6,6-tetramethyl-4-piperidyl)benzene-1,3,5-tricarboxylate, etc. Of them, triethyleneglycol-bis-3-(3-t-butyl-4-hydroxy-5-methylphenyl)-propionate, 1,6-hexane-diol-bis-3(3,5-di-t-butyl-4-hydroxy-phenyl)propionate, or tetrakis[methylene(3,5-di-t-butyl-4-hydroxyhydrocinnamate)]methane is preferably used. More preferably, triethyleneglycol-bis-3-(3-t-butyl-4-hydroxy-5-methylphenyl)-propionate is used.

The antioxidant is used in an amount of 0.01-1.0 parts by weight, and preferably, 0.1-0.5 parts by weight, based on 100 parts by weight of the POM polymer. If the antioxidant is used in an amount less than 0.01 parts by weight, thermal stability of POM becomes poor. Contrarily, if the antioxidant is used in an amount exceeding 1.0 part by weight, the effects of the antioxidant are not further increased.

In addition, a thermal stabilizer (D) used in the present invention is exemplified by nitrogen-containing compounds which function to increase the thermal stability of the POM polymer by reaction with formaldehyde, for example, 6-phenyl-1,3,5-triazine-2,4-triamine (benzoguanamine), 2,4,6-triamino-1,3,5-triazine (melamine), carbonyldiamide (urea), dicyandiamide, isophthalic dihydrazide (hydrazine), or alcohols, for example, polyethyleneglycol, ethylene-vinylalcohol copolymer, sorbitol, sorbitan, etc. In particular, 2,4,6-triamino-1,3,5-triazine (melamine) is preferably used. The thermal stabilizer is used in an amount of 0.01-2.0 parts by weight, and preferably, 0.1-1.0 parts by weight, based on 100 parts by weight of the POM polymer. When the thermal stabilizer is used in an amount exceeding 2.0 parts by weight, the properties of final shaped articles are deteriorated.

Further, a reinforcing agent (E) which is selected from among glass fiber, carbon fiber, whisker, carbon black, graphite, molybdenum disulfide, calcium carbonate, talcum, and combinations thereof, if necessary, is used in an amount of 50 parts by weight or less, based on 100 parts by weight of the POM composition.

Thus, even if the POM composition containing magnesium stearate of the present invention is in contact with fuel for a long period, it has stable mechanical properties, weight and dimensions, and as well, is highly producible. Thereby, the POM composition of the present invention can be usefully applied to manufacture automotive components requiring fuel resistance.

A better understanding of the present invention may be obtained through the following examples and comparative examples which are set forth to illustrate, but are not to be construed as the limit of the present invention.

### EXAMPLES 1-2 AND COMPARATIVE EXAMPLES 1-6

In the present examples and comparative examples, variation of properties of a POM composition with the kind of inorganic antacid was assayed.

1. Preparation of POM Composition

KEPITAL F25-03H (Korea Engineering Plastics Co. Ltd.) as a POM, 0.2 phr of 1010 (songnox, tetrakis[methylene(3,5-di-t-butyl-4-hydroxyhydrocinnamate)]methane, Songwon Industrial Co. Ltd., Korea) as an antioxidant, 0.1 phr of melamine (Samsung Fine Chemicals Co. Ltd., Korea) as a thermal stabilizer, and 1.0 phr of each inorganic antacid shown in Table 1, below, were mixed and extruded at 170-230° C., to pellet POM compositions. Each POM composition was injection molded at 170-210° C., to manufacture test samples, which were shown as POM compositions of Example 1 and Comparative Examples 1-6 in Table 2, below. In addition, a test sample of POM composition without a thermal stabilizer was prepared and shown as a POM composition of Example 2 in Table 2, below.

TABLE 1

| Inorganic | | | M.P. | Outer |
|---|---|---|---|---|
| Antacid | Formula | M.W. | (° C.) | Appearance |
| Magnesium | MgO | 40 | 2,800 | White Powder |
| Oxide | | | | |
| Magnesium | Mg(C₁₇H₃₅COO)₂ | 591 | 120˜135 | White Powder |
| Stearate | | | | |
| Calcium Oxide | CaO | 56 | 2,900 | White Powder |
| Calcium | Ca(C₁₇H₃₅COO)₂ | 607 | 150˜160 | White Powder |
| Stearate | | | | |
| Zinc Oxide | ZnO | 81 | 2,250 | White Powder |
| Zinc Stearate | Zn(C₁₇H₃₅COO)₂ | 632 | 116˜125 | White Powder |

2. Assay of Properties

Tensile strength, tensile elongation, weight change, and dimension change of the test samples of Examples 1-2 and Comparative Examples 1-6 were measured to determine the fuel resistance of each POM composition. The results are given in Table 2, below.

Each test sample was immersed in diesel fuel (containing 1 wt % sulfur) at 100° C. for 0, 500 and 1000 hrs using a container able to withstand high temperature and high pressure. Then, tensile strength, tensile elongation, weight change and dimension change of the samples were measured in accordance with the following procedures.

(Tensile Strength and Tensile Elongation)

Tensile strength and tensile elongation were measured at a test speed of 5 mm/min and a gauge length of 115 mm using a UTM (Universal Testing Machine).

(Weight Change)

After the surface of the test sample removed from the diesel fuel was wiped clean, the test sample was weighed within 5 min using a chemical balance.

(Dimension Change)

After the surface of the test sample removed from the diesel fuel was wiped clean, the dimension of the test sample was measured within 5 min using vernier calipers.

TABLE 2

| | Inorganic | | Immersion Time (hr) | | |
|---|---|---|---|---|---|
| No. | Antacid | Properties | 0 | 500 | 1000 |
| C. Ex. 1 | — | Tensile Strength (kgf/cm²) | 592 (100%) | 586 (99%) | 516 (87%) |
| | | Tensile Elongation (%) | 74 (100%) | 59 (80%) | 8 (11%) |
| | | Weight Change | Standard | +1.0% | +0.6% |
| | | Dimension Change (thickness) | Standard | +1.1% | +1.0% |
| C. Ex. 2 | ZnO | Tensile Strength (kgf/cm²) | 602 (100%) | 590 (98%) | 579 (96%) |
| | | Tensile Elongation (%) | 70 (100%) | 82 (117%) | 31 (44%) |
| | | Weight Change | Standard | +0.6% | +0.2% |
| | | Dimension Change (thickness) | Standard | +0.7% | +0.4% |
| C. Ex. 3 | Zn-St | Tensile Strength (kgf/cm²) | 575 (100%) | 562 (98%) | 562 (98%) |
| | | Tensile Elongation (%) | 75 (100%) | 54 (72%) | 50 (67%) |
| | | Weight Change | Standard | +0.4% | −0.1% |
| | | Dimension Change (thickness) | Standard | +0.6% | +0.2% |
| C. Ex. 4 | CaO | Tensile Strength (kgf/cm²) | 579 (100%) | 576 (99%) | 572 (99%) |
| | | Tensile Elongation (%) | 54 (100%) | 65 (120%) | 68 (126%) |
| | | Weight Change | Standard | +0.7% | +0.6% |
| | | Dimension Change (thickness) | Standard | +0.3% | +0.8% |
| C. Ex. 5 | Ca-St | Tensile Strength (kgf/cm²) | 579 (100%) | 562 (97%) | 557 (96%) |
| | | Tensile Elongation (%) | 52 (100%) | 78 (150%) | 68 (131%) |
| | | Weight Change | Standard | +0.4% | +0.1% |
| | | Dimension Change (thickness) | Standard | +0.6% | +0.5% |
| C. Ex. 6 | MgO | Tensile Strength (kgf/cm²) | 598 (100%) | 594 (99%) | 594 (99%) |
| | | Tensile Elongation (%) | 54 (100%) | 67 (124%) | 72 (133%) |
| | | Weight Change | Standard | +1.2% | +1.2% |
| | | Dimension Change (thickness) | Standard | +0.6% | +0.8% |
| Ex. 1 | Mg-St | Tensile Strength (kgf/cm²) | 580 (100%) | 576 (99%) | 575 (99%) |
| | | Tensile Elongation (%) | 64 (100%) | 91 (142%) | 91 (142%) |
| | | Weight Change | Standard | +1.1% | +1.2% |
| | | Dimension Change (thickness) | Standard | +0.9% | +1.1% |
| Ex. 2 | Mg-St | Tensile Strength (kgf/cm²) | 585 (100%) | 583 (100%) | 572 (98%) |
| | | Tensile Elongation (%) | 51 (100%) | 60 (118%) | 62 (122%) |
| | | Weight Change | Standard | +1.0% | +1.3% |
| | | Dimension Change (thickness) | Standard | +0.8% | +1.0% |

ZnO: zinc oxide
Zn-St: zinc stearate
CaO: calcium oxide
Ca-St: calcium stearate
MgO: magnesium oxide
Mg-St: magnesium stearate

As is apparent from Table 2, it can be shown that the retention of tensile strength and tensile elongation differs in accordance with the kind of inorganic antacid, and the POM composition has high fuel resistance (diesel resistance) when it comprises magnesium stearate.

### EXAMPLE 3

A POM composition was prepared in the same manner as in Example 1, with the exception of further including 25 parts by weight of glass fiber as a reinforcing agent, after which the properties of the POM composition were measured. The results are given in Table 3, below.

### COMPARATIVE EXAMPLE 7

A POM composition was prepared in the same manner as in Comparative Example 1, with the exception of further including 25 parts by weight of glass fiber as a reinforcing agent, after which the properties of the POM composition were measured. The results are given in Table 3, below.

TABLE 3

| | Inorganic | | Immersion Time (hr) | | |
|---|---|---|---|---|---|
| No. | Antacid | Properties | 0 | 500 | 1000 |
| C. Ex. 7 | — | Tensile Strength (kgf/cm²) | 1400 (100%) | 840 (60%) | 321 (23%) |
| | | Tensile Elongation (%) | 1 | 0.6 | 0.2 |
| | | Weight Change | Standard | +1.2% | −0.8% |
| | | Dimension Change (thickness) | Standard | +0.1% | +0.2% |
| Ex. 3 | Mg-St | Tensile Strength (kgf/cm²) | 1400 (100%) | 980 (70%) | 900 (64%) |
| | | Tensile Elongation (%) | 1 | 0.8 | 0.7 |
| | | Weight Change | Standard | +1.2% | +1.4% |
| | | Dimension Change (thickness) | Standard | +0.1% | +0.2% |

As is apparent from Table 3, it can be seen that the POM composition reinforced with glass fiber has high diesel fuel resistance (fuel resistance) when it comprises magnesium stearate.

### INDUSTRIAL APPLICABILITY

Since the POM composition containing magnesium stearate of the present invention has stable tensile strength, tensile elongation, weight and dimension even though it is in contact with fuel, it has drastically improved fuel resistance.

1. A polyoxymethylene composition having high fuel resistance, comprising:
100 parts by weight of polyoxymethylene polymer (A);
1-2.0 parts by weight of magnesium stearate (B); and
0.01-1.0 parts by weight of an antioxidant (C).

2. The polyoxymethylene composition according to claim 1, further comprising 0.01-2.0 parts by weight of a thermal stabilizer (D).

3. The polyoxymethylene composition according to claim 1, further comprising 50 parts by weight or less of a reinforcing agent (E).

4. A shaped article, produced from the polyoxymethylene composition of claim 1.

5. A shaped article, produced from the polyoxymethylene composition of claim 3.

6. The polyoxymethylene composition according to claim 2, further comprising 50 parts by weight or less of a reinforcing agent (E).

7. A shaped article, produced from the polyoxymethylene composition of claim 2.

8. The polyoxymethylene composition according to claim 7, further comprising 50 parts by weight or less of a reinforcing agent (E).
